(19) United States
(12) Patent Application Publication
(10) Pub. No.: US 2021/0216719 A1
(43) Pub. Date: Jul. 15, 2021

(54) MACHINE-LEARNING BASED PROCESSING AND REPORTING OF PROPOSAL DATA

(71) Applicant: International Business Machines Corporation, Armonk, NY (US)

(72) Inventors: Ruchi Mahindru, Elmsford, NY (US); Prathima Maskeri, Chantilly, VA (US)

(73) Assignee: International Business Machines Corporation, Armonk, NY (US)

(21) Appl. No.: 16/741,117

(22) Filed: Jan. 13, 2020

(51) Int. Cl. G06F 40/30; G06N 3/00; G06Q 10/10; G06F 40/205; G06F 40/295

(52) U.S. Cl. CPC G06F 40/30; G06N 3/006; G06Q 30/0203; G06F 40/205; G06F 40/295; G06Q 10/10

(57) ABSTRACT

An embodiment parses request data representative of a request for proposal (RFP) and extracts attribute data representative of an RFP attribute that corresponds to an entity of interest in a qualification taxonomy using a cognitive process to evaluate the RFP using natural language processing. The embodiment generates answer data representative of an answer to a first question of a qualification questionnaire related to the entity of interest using the RFP attribute. The embodiment constructs the answer data based at least in part on a response pattern associated with the first question, and computes a score for the answer to the first question based at least in part on a confidence value generated by the cognitive process. The embodiment then outputs the qualification questionnaire, including the answer and the score, allowing for review by a Subject Matter Expert (SME), and allowing the cognitive process to learn from the SME review.

### TECHNICAL FIELD

The present invention relates generally to a method, system, and computer program product for digital file evaluations. More particularly, the present invention relates to a method, system, and computer program product for machine-learning based processing and reporting of proposal data.

### BACKGROUND

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A Deep Learning Neural Network, referred to herein as a Deep Neural Network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks.

### SUMMARY

The illustrative embodiments provide for machine-learning based processing and reporting of proposal data. An embodiment includes parsing, by a processor, request data representative of a request for proposal (RFP). The embodiment also includes extracting, by the processor, attribute data representative of an attribute of the RFP that corresponds to an entity of interest in a qualification taxonomy using a cognitive process to evaluate the RFP using natural language processing (NLP). The embodiment also includes generating, by the processor, answer data representative of an answer to a first question of a qualification questionnaire related to the entity of interest in the qualification taxonomy using the attribute of the RFP, wherein the generating of the answer data includes constructing the answer data based at least in part on a response pattern associated with the first question of the qualification questionnaire. The embodiment also includes computing, by the processor, a score for the answer to the first question of the qualification questionnaire based at least in part on a confidence value generated by the cognitive process. The embodiment also includes outputting, by the processor, the qualification questionnaire including the answer and the score for the answer. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3A depicts a block diagram of an example configuration for a qualification form generation system in accordance with an illustrative embodiment;

FIG. 3B depicts a block diagram of an example qualification taxonomy configuration for a qualification form generation system in accordance with an illustrative embodiment;

FIG. 4A depicts a first portion of a flowchart of an example process for automatically preparing a qualification questionnaire responsive to receiving an RFP in accordance with an illustrative embodiment;

FIG. 4B depicts a second portion of a flowchart of an example process for automatically preparing a qualification questionnaire responsive to receiving an RFP in accordance with an illustrative embodiment; and

FIG. 5 depicts a flowchart of an example process for associating the extracted RFP entity data with entries of the qualification form by matching RFP entity data with predefined entities and response patterns of a qualification form in accordance with an illustrative embodiment.

### DETAILED DESCRIPTION

A Request for Proposal (RFP) is a document that invites a vendor to submit a bid for goods or services. RFPs can come in a variety of formats, but usually provide detailed information that outlines key elements of a project. A typical RFP process generally involves a customer submitting RFPs to pre-selected vendors in order to receive competing bids for a given project. For example, a typical RFP process begins with a customer drafting an RFP and sending it to multiple vendors. The vendors review the RFP and respond with their proposals. The customer then selects a vendor to handle the project based on the responses to the RFP.

Thus, for a vendor that receives an RFP, it represents a new potential business opportunity, so the preparation of a proposal in response to the RFP is an important task. The process of preparing a response to an RFP usually involves carefully evaluating the project requirements and preparing a detailed proposal that explains how the vendor will complete the project. A proposal typically includes project parameters, such as schedule and pricing information, that will be compared to other proposals. Importantly, if a proposal is selected by the requesting customer, the vendor will be expected to be contractually bound by the proposed project parameters. Therefore, it is important for the vendor to carefully review the RFP and develop a comprehensive understanding of the proposed project in order to be able to prepare a proposal that is both feasible and competitive.

The use of RFPs is pervasive in many industries, including those involving new or emerging technologies. For example, companies transitioning towards cloud-based solutions to take advantage of economical and agile deployment options frequently issue RFPs to multiple vendors they deem qualified to complete the project. Such RFPs are typically very complex and unique. A customer preparing an RFP typically has its own personalized, unique manner of organizing the RFP and explaining the scope of the project sought to be completed. Currently, reviewing an RFP for the purpose of preparing a proposal is a manual process that requires gaining a comprehensive understanding of the customer's business requirements and developing a solution that satisfies those requirements. This is a highly time-consuming and manual process that is expensive and susceptible to human error. Thus, the illustrative embodiments recognize that the size, complexity, and diverse styles of RFPs present an obstacle to efficiently reviewing and responding to RFPs.

A proposal request, or “RFP,” is one of a several different types of sourcing documents. An RFP is primarily used for requesting proposals for a defined product or service. Other types of sourcing documents include a Requests for Information (RFI), which is typically used to select a supplier, and a Request for Quote (RFQ), which is sometimes synonymous with an RFP and is typically used to request a bid on a project or product. Other types of sourcing documents include an expression of interest (EOI), an invitation for bids (IFB), an invitation to tender (ITT), an invitation to vendors (ITV), a request for applications (RFA), a request for documentation (RFD), a request for offers (RFO), a request for negotiation (RFN), and a request for services (RFS). However, for the sake of simplicity, a “proposal request” or “RFP,” as used herein, refers to any type of sourcing document. Also, for the sake of simplicity, a “customer,” as used herein, refers to an entity that issues an RFP, and a “vendor,” as used herein, refers to an entity that receives and responds to an RFP, where an “entity” refers to an individual or organization, including any kind of business organization.

The illustrative embodiments recognize that there is a need to reduce the susceptibility to errors concomitant with current RFP review procedures. For example, the illustrative embodiments include an artificial intelligence (AI) based system that cognitively evaluates an incoming RFP and generates a qualification questionnaire (also referred to herein as a “qualification form”) that correlates with the RFP in a standardized format. The standardized qualification document presents the details of an RFP organized in a consistent manner to allow reviewers to gradually gain familiarity with the organization of the qualification documents. This allows a reviewer to gain an element of efficiency at reviewing the standardized qualification documents that cannot otherwise be achieved when reviewing RFPs that are different every time. Thus, a “qualification questionnaire,” as used herein, includes documents that include questions and answers, as well as documents that lack questions but include information described herein as being collected as answers for a qualification questionnaire, such as a qualification outline, summary, form, or other type of document.

The illustrative embodiments also recognize that RFPs are often time-sensitive requests that require immediate attention and efficient processing. The degree of urgency specified by the RFP sometimes results in time constraints that add to the challenging nature of reviewing and responding to RFPs. Therefore, the illustrative embodiments recognize that there is a need to reduce the amount of time required to review an RFP by employing AI-based processes to automate some aspects of the review process. For example, the illustrative embodiments include an AI-based system that cognitively evaluates an incoming RFP and generates a qualification questionnaire that includes AI-generated answers for addressing one or more aspects of the RFP. In some embodiments, the AI-generated answers include respective confidence scores based at least in part on the entities associated with the corresponding questions and context from the RFP according to processes described herein. The scoring system allows a reviewer to quickly identify aspects where the AI-generated response can likely be adopted and other aspects that require more of the reviewer's attention. Aspects requiring reviewer's attention in-turn become learning opportunities for the system to further improve the scoring based on the reviewer's explicit or implicit feedback, where explicit feedback is provided in form of clicking buttons like “useful” or “not useful,” while implicit feedback could be gathered based on the sections of the documents that the reviewer spends time on, including the duration spent on the corresponding section.

An embodiment can be implemented as a software application. The application implementing an embodiment can be configured as a modification of an existing image analysis system, as a separate application that operates in conjunction with an existing image analysis system, a standalone application, or some combination thereof.

The illustrative embodiments employ an AI-based system or process that includes Natural language processing (NLP), which is a field of computer science, artificial intelligence, and linguistics concerned with the interactions between computers and human (natural) languages. NLP involves natural language understanding, i.e. enabling computers to derive meaning from human or natural language input. Modern NLP algorithms are based on machine learning, especially statistical machine learning. Machine-learning NLP algorithms involve automatically learning rules through the analysis of large corpora of typical real-world examples. A corpus (plural, “corpora”) is a collection of textual material, such as a set of documents, portions of one or more documents, or sometimes, individual sentences. A training corpus may be such a collection of textual material that has been annotated with the correct values to be learned during a machine learning process.

In some embodiments, an AI-based system or process includes Natural language understanding (NLU), which is a subset of NLP. NLU is a subset of NLP. NLU uses algorithms to transform text into a structured ontology. Ontology functions as a structural framework to organize information and concepts. In one embodiment, the ontology includes an ontology of entities constructed from a taxonomy of a qualification questionnaire, which serves as a standardized document for summarizing requirements of, and automated responses to, a proposal request. NLU uses algorithms to disassemble and parse natural language input to determine appropriate syntactic and semantic schemes in order to derive meaning from the inputted language. In an embodiment, NLU relies on computational models that are based on linguistics to develop word meanings and correlations. In an embodiment, the NLU and NLP use a series of words to identify information about a proposal request and generate an answer for a qualification questionnaire, where the answer can be used as part of a proposal or other response to the proposal request. For example, in an embodiment, the NLP processes the series of words to identify the information about the proposal request and construct an answer for at least a part of a response, where the information is stored in a non-transitory memory and the answer is constructed utilizing NLU.

In an embodiment, the AI-based system further includes higher level natural language processing capabilities such as inferencing and deep semantic processing. In an embodiment, the AI-based system parses the information about the proposal request via one or more of a slot grammar parser, a predicate-argument structure (PAS) builder, and higher level natural language processing capabilities. In an embodiment, the AI-based system parses out insignificant language (e.g., articles, conjunctions, auxiliary verbs, pronouns, and prepositions), and, upon parsing the information about the proposal request, identifies one or more terms or entities from the proposal request corresponding to one or more entities of interest for a qualification questionnaire in order to facilitate reviewing and responding to the proposal request.

In some embodiments, an AI-based system or process facilitates parsing of information about a proposal request to determine one or more entities or terms associated with a qualification taxonomy or qualification questionnaire. In some embodiments, the AI-based system includes an English slot grammar (ESG) parser or Abstract Meaning Representation (AMR) or other natural language parsers to parse the information about the proposal request and thereby determine one or more terms or entities in the proposal request. In some embodiments, the AI-based system includes language-specific grammars for languages other than English. In an embodiment, the AI-based system further includes a PAS builder. The PAS builder simplifies results generated by the ESG, resulting in a more general form that is logically approximate to the result of the ESG parse. For example, ESG produces different parse trees for passive and active voice, whereas PAS results are the same for active and passive voice (e.g., “regular updates shall be provided by the vendor” and “the vendor shall provide regular updates” yield different part trees from ESG but reduce to the same result from PAS).

In some embodiments, an AI-based system or process extracts information from an RFP in order to identify attributes of the RFP that correspond to entities of interest in a qualification questionnaire. For example, in some embodiments, a vendor has a previously-prepared qualification questionnaire that helps the vendor assess if the requirements specified by the customer in the RFP can be satisfied by the vendor's available products or services. In some embodiments, the qualification questionnaire also serves as an input for creating solutions. In some embodiments, an AI-based system scans an RFP document from a customer and generates a qualification questionnaire ready to be output in a physical or electronic form. In some embodiments, this output can help in qualifying a proposal and can help sales personnel respond to the customer with questions quickly and also accurately gather data that is still required to complete the qualification questionnaire.

In some embodiments, a qualification taxonomy corresponding to a qualification questionnaire defines a response pattern for entities of interest in the qualification questionnaire. In some such embodiments, an AI-based system extracts information from an RFP in order to identify attributes of the RFP that correspond to the response patterns of the qualification taxonomy associated with entities of interest in a qualification questionnaire. For example, in an embodiment, a non-limiting example of an entity of interest is an Application Name, which is required information for a response to an RFP. Also, since the vendor offers a discrete list of applications, the questionnaire lists the application options and requires the answer to be a selection of one of the listed applications. In this example, the qualification taxonomy would indicate that the response pattern is something equivalent to PREDEFINED LIST, MUST RESPOND. As another non-limiting example, an entity of interest is a database size, which is not a required piece of information for a response, but can be included as a range of values, so the qualification taxonomy would indicate that the response pattern equivalent to MAX SIZE, MIN SIZE values.

In some embodiments, a qualification taxonomy corresponding to a qualification questionnaire includes an indication of question interdependencies. For example, a first non-limiting example of a question Qi relates to whether a database is needed, and a second non-limiting example of a question Qj relates to size information for a database (if included). Thus, the question Qj depends on the answer to question Qi because question Qj only needs to be answered if the answer to question Qi indicates that a database is required.

In some embodiments, a qualification taxonomy includes one or more possible weights that can be assigned to each answer depending on a product of service being proposed in response to an RFP, or depending on a context of a product or service being proposed in response to an RFP. In an embodiment, a qualification taxonomy includes one or more possible weights that can be assigned to each answer depending on a type of cloud computing service being proposed in response to the RFP. For example, in an embodiment, a vendor's offerings include cloud platform services, or Platform as a Service (PaaS), and cloud infrastructure services, known as Infrastructure as a Service (IaaS). The qualification taxonomy in this example includes a value for “Total Number of Users,” which factors into customer cost for a PaaS offering but does not factor into customer cost for an IaaS offering. Thus, for a PaaS offering, this question is assigned a weight that increases this question's significance, such as 0.5, whereas for an IaaS offering, this question is assigned a weight that diminishes this question's significance, such as 0.

In some embodiments, the illustrative embodiments include an AI-based system that cognitively evaluates an incoming RFP and generates a qualification questionnaire that includes AI-generated answers for addressing one or more aspects of the RFP. In some embodiments, the AI-generated answers include respective confidence scores based at least in part on the entities associated with the corresponding questions and context from the RFP according to processes described herein. In some such embodiments, the AI-based system detects more than one possible answer to a question. In such embodiments, the AI-based system includes respective confidence scores based at least in part on the entities associated with the corresponding questions and context from the RFP according to processes described herein, and then selects the answer with the highest possible score for use in the answer included in the qualification questionnaire. In an embodiment, the AI-based system detects multiple possible answers to a question, and the AI-based system includes respective confidence scores generated by the AI-based system for each possible answer, and then selects the top n answers having the highest scores.

In an embodiment, the illustrative embodiments include an AI-based system that cognitively evaluates an incoming RFP and generates a qualification questionnaire that includes AI-generated answers for addressing one or more aspects of the RFP and respective confidence scores based at least in part on the entities associated with the corresponding questions and context from the RFP according to processes described herein. In some embodiments, the completed qualification questionnaire with the AI-generated answers and scores is presented to a subject matter expert (SME) for manual review and as an aid for preparing a proposal or other type of response to the RFP. In some embodiments, answers with a confidence score below a configurable threshold are highlighted for SME review.

In some embodiments, an SME reviews all answers or at least the highlighted answers and provides feedback based on the SME review to the AI-based system as to the accuracy of the AI-generated answers such that the AI-based system learns from the SME review of the answers. In some embodiments, the AI-based system automatically makes adjustments based on the SME's feedback, or the SME makes adjustments and/or modifications based on the SME's review, for example adjustments to the scoring thresholds and/or modifications to response patterns and/or attributes. In some embodiments, the AI-based system increases or decreases the attribute weight for an answer because of consistent positive or negative feedback from users.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or component that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, historical data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

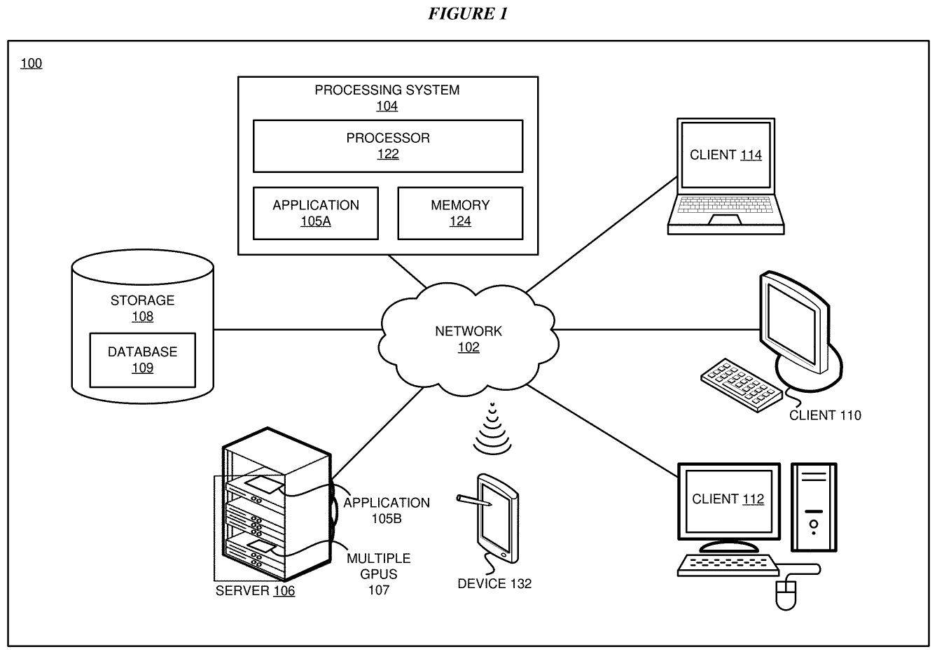

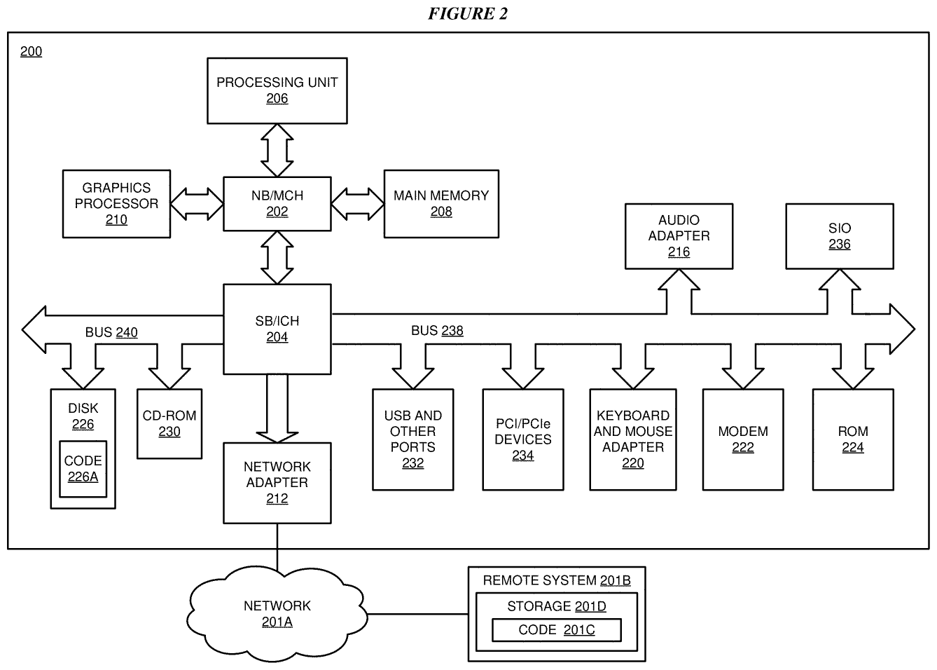

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Data processing system 104 couples to network 102. Software applications may execute on any data processing system in data processing environment 100. Any software application described as executing in processing system 104 in FIG. 1 can be configured to execute in another data processing system in a similar manner. Any data or information stored or produced in data processing system 104 in FIG. 1 can be configured to be stored or produced in another data processing system in a similar manner. A data processing system, such as data processing system 104, may contain data and may have software applications or software tools executing computing processes thereon. In an embodiment, data processing system 104 includes memory 124, which includes application 105A that may be configured to implement one or more of the data processor functions described herein in accordance with one or more embodiments.

Server 106 couples to network 102 along with storage unit 108. Storage unit 108 includes a database 109 configured to store data as described herein with respect to various embodiments, for example image data and attribute data. Server 106 is a conventional data processing system. In an embodiment, server 106 includes neural network application 105B that may be configured to implement one or more of the processor functions described herein in accordance with one or more embodiments.

Clients 110, 112, and 114 are also coupled to network 102. A conventional data processing system, such as server 106, or client 110, 112, or 114 may contain data and may have software applications or software tools executing conventional computing processes thereon.

Only as an example, and without implying any limitation to such architecture, FIG. 1 depicts certain components that are usable in an example implementation of an embodiment. For example, server 106, and clients 110, 112, 114, are depicted as servers and clients only as example and not to imply a limitation to a client-server architecture. As another example, an embodiment can be distributed across several data processing systems, and a data network as shown, whereas another embodiment can be implemented on a single data processing system within the scope of the illustrative embodiments. Conventional data processing systems 106, 110, 112, and 114 also represent example nodes in a cluster, partitions, and other configurations suitable for implementing an embodiment.

Device 132 is an example of a conventional computing device described herein. For example, device 132 can take the form of a smartphone, a tablet computer, a laptop computer, client 110 in a stationary or a portable form, a wearable computing device, or any other suitable device. In an embodiment, device 132 sends requests to server 106 to perform one or more data processing tasks by neural network application 105B such as initiating processes described herein of the neural network. Any software application described as executing in another conventional data processing system in FIG. 1 can be configured to execute in device 132 in a similar manner. Any data or information stored or produced in another conventional data processing system in FIG. 1 can be configured to be stored or produced in device 132 in a similar manner.

Server 106, storage unit 108, data processing system 104, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 106 may provide data, such as boot files, operating system images, and applications to clients 110, 112, and 114. Clients 110, 112, and 114 may be clients to server 106 in this example. Clients 110, 112, 114, or some combination thereof, may include their own data, boot files, operating system images, and applications. Data processing environment 100 may include additional servers, clients, and other devices that are not shown.

In the depicted example, memory 124 may provide data, such as boot files, operating system images, and applications to processor 122. Processor 122 may include its own data, boot files, operating system images, and applications. Data processing environment 100 may include additional memories, processors, and other devices that are not shown.

In an embodiment, one or more of application 105A of data processing system 104 and application 105B of server 106 implements an embodiment of an AI-based system, such as an NLP system, as described herein. In a particular embodiment, the AI-based system is implemented using one of network application 105A and network application 105B within a single server or processing system. In another particular embodiment, the AI-based system is implemented using both network application 105A and network application 105B within a single server or processing system. Server 106 includes multiple GPUs 107 including multiple nodes in which each node may include one or more GPUs as described herein.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a conventional client data processing system and a conventional server data processing system. Data processing environment 100 may also employ a service-oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a conventional computer, such as data processing system 104, server 106, or clients 110, 112, and 114 in FIG. 1, or another type of device in which computer usable program code or instructions implementing the processes may be located for the illustrative embodiments.

Data processing system 200 is also representative of a conventional data processing system or a configuration therein, such as conventional data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid-state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

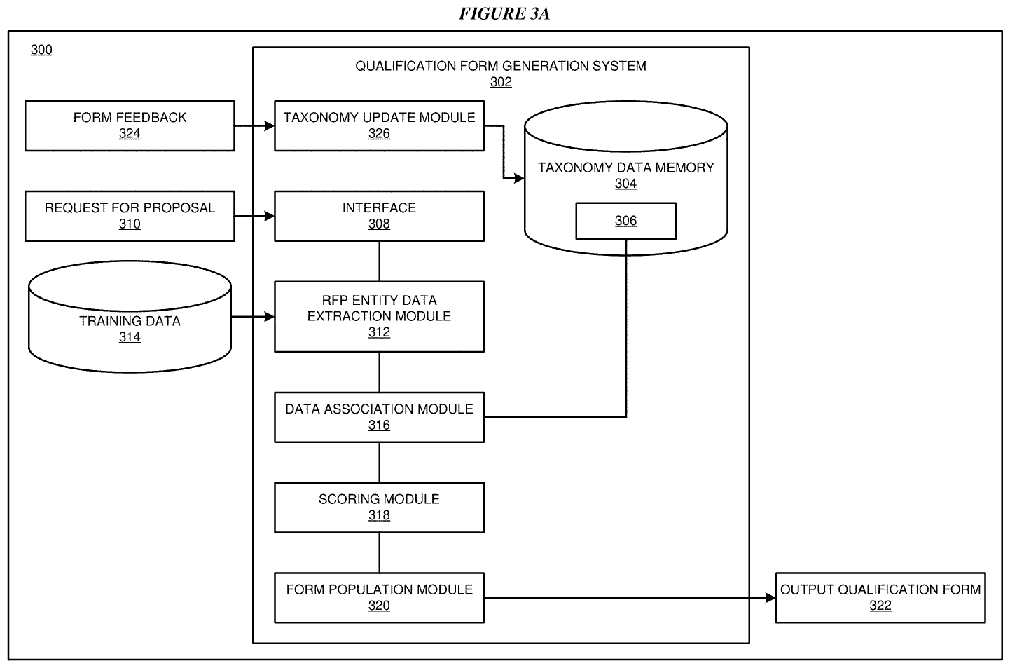

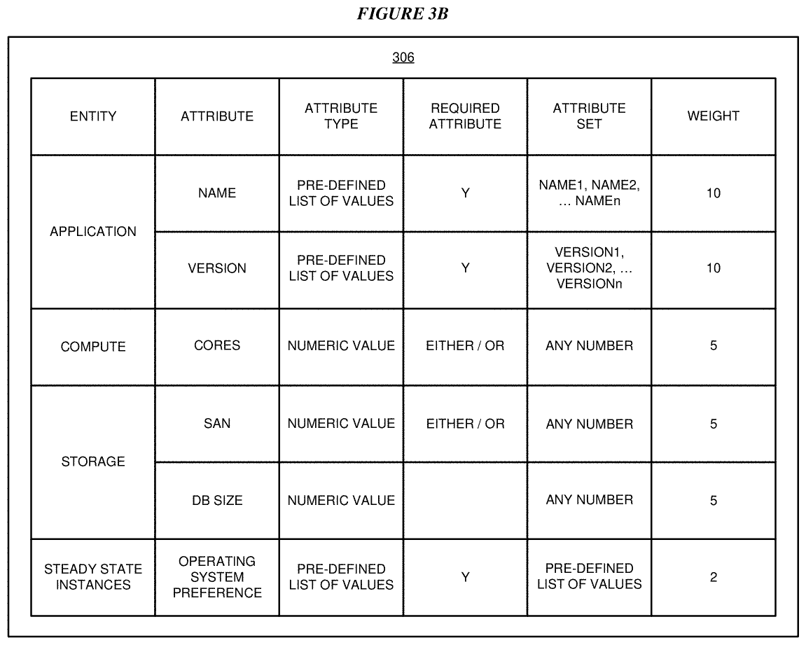

With reference to FIGS. 3A and 3B, these figures depict an example configuration 300 in accordance with an illustrative embodiment. More specifically, FIG. 3A depicts a block diagram of an example configuration for a qualification form generation system in accordance with an illustrative embodiment, and FIG. 3B depicts a block diagram of an example qualification taxonomy configuration for a qualification form generation system in accordance with an illustrative embodiment. The example embodiment includes a qualification form generation system 302. In a particular qualification form generation system 302 is an example of application 105A/105B of FIG. 1.

In the illustrated embodiment, the qualification form generation system 302 includes a taxonomy data memory 304 for storing a qualification taxonomy 306. In the illustrated embodiment, a non-limiting example of a qualification taxonomy 306 is shown in FIG. 3B that includes four entities of interest listed in the first column: APPLICATION, COMPUTE, STORAGE, and STEADY STATE INSTANCES.

The APPLICATION entity has two attributes: NAME and VERSION. The NAME attribute and VERSION attribute are required attributes that must be selected from respective predefined lists of values (i.e., NAME 1-NAMEn; VERSION 1-VERSIONn).

The COMPUTE entity has one attribute: CORES. The CORES attribute is an EITHER/OR attribute that must be CORES or vCPU and can specify ANY NUMBER as a NUMERIC VALUE associated with a number of cores or vCPUs.

The STORAGE entity has two attributes: SAN and DB SIZE. The SAN attribute is an EITHER/OR attribute that must be SAN or NAS and can specify ANY NUMBER as a NUMERIC VALUE attribute associated with a SAN or NAS. The DB SIZE is not required, and can be ANY NUMBER as a NUMERIC VALUE.

The STEADY STATE INSTANCES entity has one attribute: OPERATING SYSTEM PREFERENCE. The OPERATING SYSTEM PREFERENCE is a required attribute that must be selected from a PREDEFINED LIST OF VALUES.

In the illustrated embodiment, the qualification form generation system 302 includes an interface 308 for receiving an RFP 310 from a customer or other entity. In an embodiment, the interface 308 includes a web interface that allows customers to upload their RFP documents. In an embodiment, upon receiving the RFP 310, the interface 308 automatically initiates a process for generating a qualification form or questionnaire and populating the questionnaire or form with answers using an AI-based cognitive process. For example, in an embodiment, the interface 308 transmits the RFP to an RFP entity data extraction module 312. In an embodiment, the RFP entity data extraction module 312 performs NLP processing as described herein to extract attributes of the RFP that correspond to entities of interest in the qualification questionnaire. In an embodiment, the RFP entity data extraction module 312 includes a machine-learning algorithm that is trained using training data 314 to recognize salient aspects of the RFP 310 for extraction.

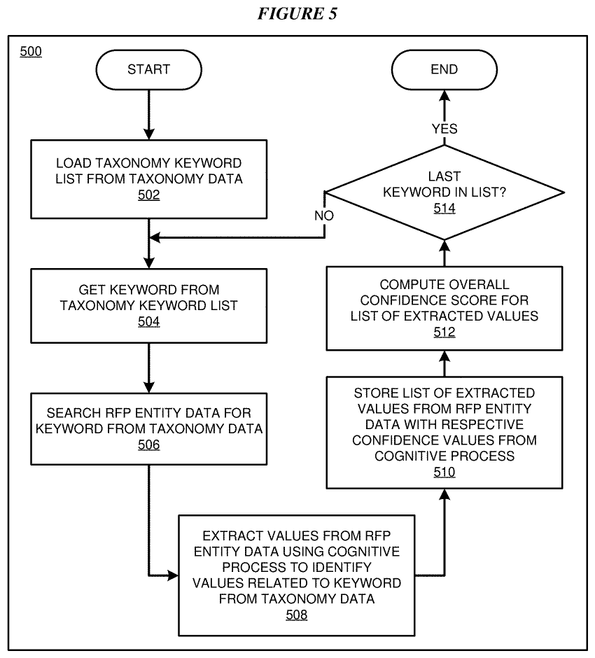

In the illustrated embodiment, the attributes extracted from the RFP are transmitted to a data association module 316, which also receives taxonomy data, such as a qualification taxonomy 306 from the taxonomy data memory 304. In an embodiment, the data association module 316 associates the extracted RFP entity data with entries of the qualification form by matching RFP entity data with predefined entities and response patterns of qualification form. For example, in an embodiment, the data association module 316 associates the extracted RFP entity data with entries of the qualification form according to a process shown in FIG. 5.

In the illustrated embodiment, the associated RFP entity data is transmitted to a scoring module 318 for scoring and to a form population module 320 for populating a qualification form. In an embodiment, the scoring module 318 calculates scores for each of the questions of the qualification questionnaire based at least in part on the entities associated with the corresponding questions and context from the RFP according to processes described herein. For example, in an embodiment, the scoring module 318 calculates a score for a question based at least in part on a number of other questions upon which the question depends, and a number of other questions that depend on the question. In an embodiment, the scoring module 318 calculates a score for a question based at least in part on one or more scores of questions upon which the question depends. In an embodiment, the scoring module 318 calculates a score for a question based at least in part on whether the question is required. In an embodiment, the scoring module 318 calculates a score for a question based at least in part on a context of the question, for example based on a weight assigned to the question, such as a first weight if the question indicates a PaaS offering and a second weight if the question indicates an IaaS offering.

In an embodiment, the form population module 320 appends the associated RFP entity data and the scores to a qualification form, which is then output as output qualification form 322 to an SME or other reviewing entity.

In the illustrated embodiment, the qualification form generation system 302 includes a taxonomy update module 326 that allows a user to make changes to the qualification taxonomy 306. For example, an SME may wish to update the qualification taxonomy 306 by providing form feedback 324 to the system 302 after reviewing the output form 322.

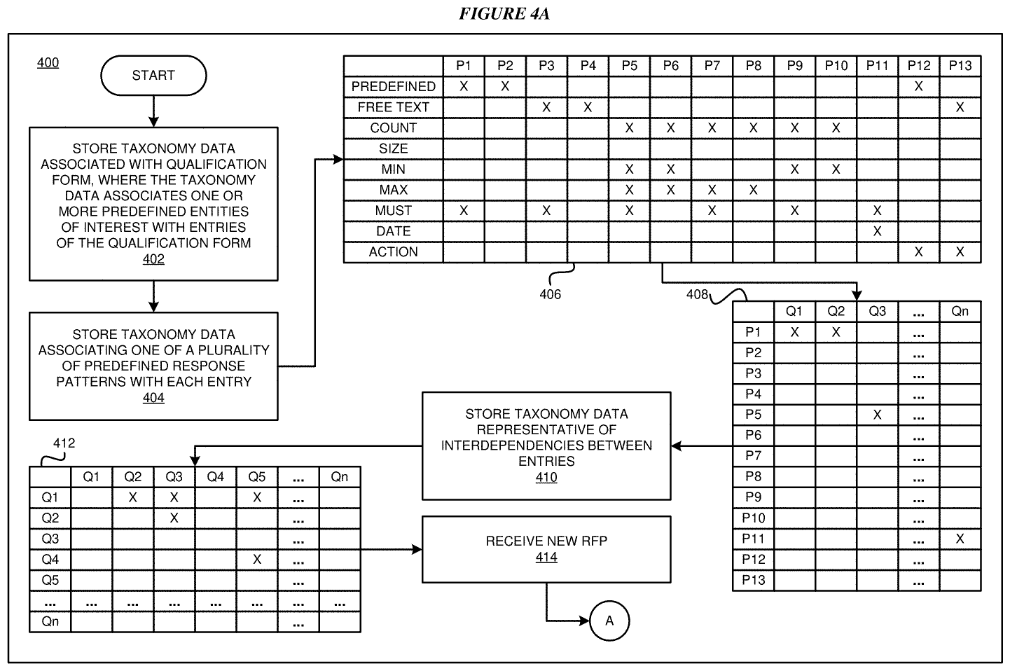

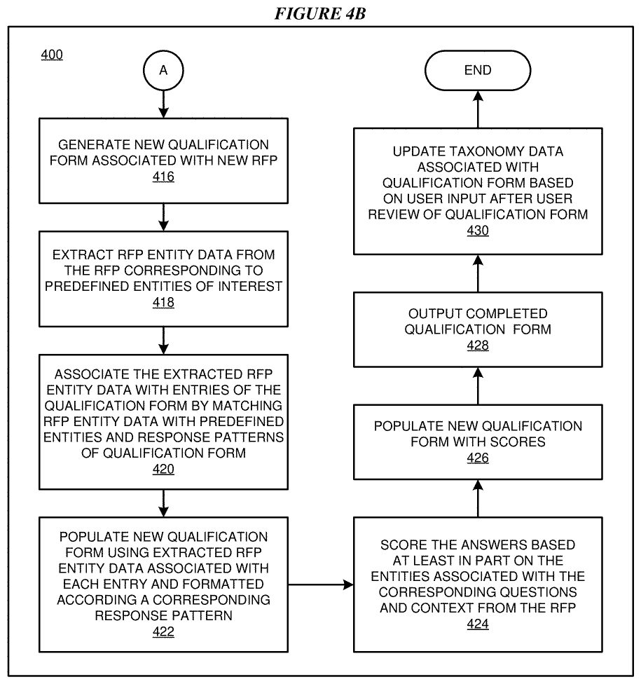

With reference to FIGS. 4A and 4B, these figures depict first and second portions, respectively, of a flowchart of an example process 400 for automatically preparing a qualification questionnaire responsive to receiving an RFP in accordance with an illustrative embodiment. In a particular embodiment, the qualification form generation system 302 carries out the process 400 using software instructions for a taxonomy builder.

In an embodiment, at block 402, taxonomy builder stores taxonomy data associated with a qualification form. In an embodiment, at block 404, taxonomy builder stores taxonomy data associating one of a plurality of predefined response patterns with each entry. For example, in the illustrated embodiment, a pattern table 406 shows a plurality of possible response patterns that the taxonomy builder detects for each question or entry of the qualification form associated with the taxonomy data. In an embodiment, non-limiting examples of possible response patterns that the taxonomy builder detects include the patterns P1-P13 explained below.
P1. PREDEFINED, MUST: The response selects from predefined options and the response is required.
P2. PREDEFINED: The response selects from predefined options (optional response).
P3. FREE TEXT, MUST: The response can include free-form text and the response is required.
P4. FREE TEXT: The response can include free-form text (optional response).
P5. COUNT, MIN, MAX, MUST: The response includes a range of total amounts, including minimum and maximum totals, and the response is required.
P6. COUNT, MIN, MAX: The response includes a range of total amounts, including minimum and maximum totals (optional response).
P7. COUNT, MAX, MUST: The response includes a total maximum amount, e.g., total cap value, and the response is required.
P8. COUNT, MAX: The response includes a total maximum amount, e.g., total cap value (optional response).
P9. COUNT, MIN, MUST: The response includes a total minimum amount, and the response is required.
P10. COUNT, MIN: The response includes a total minimum amount (optional response).
P11. DATE, MUST: The response must be a data and is required.
P12. PREDEFINED, ACTION: The response involves a predefined action.
P13. FREE TEXT, ACTION: The response involves free-form action.

In an embodiment, at block 404, taxonomy builder identifies and associates each entry or question with one of the response patterns P1-P13 as shown in block 408. As a non-limiting example, question pattern table 408 shows that questions Q1-Q2 both require response pattern P1, question Q3 requires pattern P5, and the last question Qn (where n is any value) requires response pattern P11. In an embodiment, the process at block 404 includes an AI-based system, such as NLP to detect the patterns for each of the questions.

At block 410, the taxonomy builder stores taxonomy data representative of interdependencies between entries. As a non-limiting example, question dependency table 412 shows that the answers to questions Q2-Q3 and Q5 depend on the answer to question Q1, the answer to question Q3 also depends on the answer to question Q2, and the answer to question Q5 also depends on the answer to question Q4. At block 414, the taxonomy builder receive a new RFP. At block 416, the taxonomy builder generates a new qualification form associated with new RFP.

At block 418, the taxonomy builder extracts RFP entity data from the RFP corresponding to predefined entities of interest. At block 420, the taxonomy builder associates the extracted RFP entity data with entries of the qualification form by matching RFP entity data with predefined entities and response patterns of qualification form. In an embodiment, the taxonomy builder associates the extracted RFP entity data with entries of the qualification form according to the process shown in FIG. 5. At block 422, the taxonomy builder populates the new qualification form using extracted RFP entity data associated with each entry and formatted according a corresponding response pattern. At block 424, the taxonomy builder scores the answers based at least in part on the entities associated with the corresponding questions and context from the RFP. At block 426, the taxonomy builder populates the new qualification form with the scores. At block 428, the taxonomy builder outputs the completed qualification form. Finally, at block 430, the taxonomy builder updates the taxonomy data associated with the qualification form based on user input after user review of qualification form.

With reference to FIG. 5, this figure depicts a flowchart of an example process 500 for associating the extracted RFP entity data with entries of the qualification form by matching RFP entity data with predefined entities and response patterns of a qualification form in accordance with an illustrative embodiment. In a particular embodiment, the process 500 is an embodiment of the process at block 420 shown in FIG. 4 performed by the taxonomy builder.

At block 502, the taxonomy builder loads a taxonomy keyword list from taxonomy data stored in memory. Next, at block 504, the taxonomy builder gets a keyword from the taxonomy keyword list. At block 506, the taxonomy builder searches RFP entity data for the keyword from the taxonomy data. At block 508, the taxonomy builder extracts values from the RFP entity data using a cognitive process to identify values related to the keyword from the taxonomy data. At block 510, the taxonomy builder stores a list of extracted values from RFP entity data with respective confidence values from the cognitive process. At block 512, the taxonomy builder computes an overall confidence score for the list of extracted values. At block 514, the taxonomy builder checks whether the current keyword is the last keyword in list. If not, the process continues back to block 504. Otherwise, the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method comprising:
parsing, by a processor, request data representative of a request for proposal (RFP);
extracting, by the processor, attribute data representative of an attribute of the RFP that corresponds to an entity of interest in a qualification taxonomy using a cognitive process to evaluate the RFP using natural language processing (NLP);
generating, by the processor, answer data representative of an answer to a first question of a qualification questionnaire related to the entity of interest in the qualification taxonomy using the attribute of the RFP, wherein the generating of the answer data includes constructing the answer data based at least in part on a response pattern associated with the first question of the qualification questionnaire;
computing, by the processor, a score for the answer to the first question of the qualification questionnaire based at least in part on a confidence value generated by the cognitive process; and
outputting, by the processor, the qualification questionnaire including the answer and the score for the answer.

2. The computer implemented method of claim 1, further comprising:
defining a scoring threshold; and
highlighting the answer in the qualification questionnaire if the score is below the scoring threshold.

3. The computer implemented method of claim 1, wherein said score is further based at least in part on a determination that the first question depends on another question of the qualification questionnaire.

4. The computer implemented method of claim 3, wherein said score is further based at least in part on a score of the other question upon which the question depends.

5. The computer implemented method of claim 3, wherein said score is further based at least in part on a determination that a third question of the qualification questionnaire depends on the first question.

6. The computer implemented method of claim 1, further comprising assigning a first weight to the first question based at least in part on a service being proposed in response to the RFP.

7. The computer implemented method of claim 6, wherein said score is further based at least in part on the first weight assigned to the first question.

8. The computer implemented method of claim 6, wherein said first weight is further based at least in part on a second weight that is assigned to a second question upon which the first question depends.

9. A computer program product for cognitive evaluation of proposal requests, the computer program product comprising one or more computer readable storage media, and program instructions collectively stored on the one or more computer readable storage media, the program instructions executable by controller circuitry to cause the controller circuitry to perform operations comprising:
parsing request data representative of a request for proposal (RFP);
extracting attribute data representative of an attribute of the RFP that corresponds to an entity of interest in a qualification taxonomy using a cognitive process to evaluate the RFP using natural language processing (NLP);
generating answer data representative of an answer to a first question of a qualification questionnaire related to the entity of interest in the qualification taxonomy using the attribute of the RFP, wherein the generating of the answer data includes constructing the answer data based at least in part on a response pattern associated with the first question of the qualification questionnaire;
computing a score for the answer to the first question of the qualification questionnaire based at least in part on a confidence value generated by the cognitive process; and
outputting the qualification questionnaire including the answer and the score for the answer.

10. The computer usable program product of claim 9, wherein the stored program instructions are stored in a computer readable storage device in a data processing system, and wherein the stored program instructions are transferred over a network from a remote data processing system.

11. The computer usable program product of claim 9, wherein the stored program instructions are stored in a computer readable storage device in a server data processing system, and wherein the stored program instructions are downloaded over a network to a remote data processing system for use in a computer readable storage device associated with the remote data processing system, further comprising:
program instructions to meter use of the computer usable code associated with the request; and
program instructions to generate an invoice based on the metered use.

12. The computer usable program product of claim 9, the operations further comprising:
defining a scoring threshold; and
highlighting the answer in the qualification questionnaire if the score is below the scoring threshold.

13. The computer usable program product of claim 9, wherein said score is further based at least in part on a determination that the first question depends on a second question of the qualification questionnaire.

14. The computer usable program product of claim 13, wherein said score is further based at least in part on a score of the second question upon which the question depends.

15. The computer usable program product of claim 13, wherein said score is further based at least in part on a determination that a third question of the qualification questionnaire depends on the first question.

16. A computer system comprising a processor and one or more computer readable storage media, and program instructions collectively stored on the one or more computer readable storage media, the program instructions executable by the processor to cause the processor to perform operations comprising:
parsing request data representative of a request for proposal (RFP);
extracting attribute data representative of an attribute of the RFP that corresponds to an entity of interest in a qualification taxonomy using a cognitive process to evaluate the RFP using natural language processing (NLP);
generating answer data representative of an answer to a first question of a qualification questionnaire related to the entity of interest in the qualification taxonomy using the attribute of the RFP, wherein the generating of the answer data includes constructing the answer data based at least in part on a response pattern associated with the first question of the qualification questionnaire;
computing a score for the answer to the first question of the qualification questionnaire based at least in part on a confidence value generated by the cognitive process; and
outputting the qualification questionnaire including the answer and the score for the answer.

17. The computer system of claim 16, the operations further comprising:
defining a scoring threshold; and
highlighting the answer in the qualification questionnaire if the score is below the scoring threshold.

18. The computer system of claim 16, wherein said score is further based at least in part on a determination that the first question depends on a second question of the qualification questionnaire.

19. The computer system of claim 18, wherein said score is further based at least in part on a score of the second question upon which the question depends.

20. The computer system of claim 18, wherein said score is further based at least in part on a determination that a third question of the qualification questionnaire depends on the first question.
